(19) United States
(12) Patent Application Publication
(10) Pub. No.: US 2015/0134963 A1
(43) Pub. Date: May 14, 2015

(54) NODE DEVICE AND COMMUNICATION METHOD

(71) Applicant: FUJITSU LIMITED, Kawasaki-shi (JP)

(72) Inventors: Tetsuya IZU, London (GB); Yumi SAKEMI, Kawasaki (JP)

(73) Assignee: FUJITSU LIMITED, Kawasaki-shi (JP)

(21) Appl. No.: 14/600,383

(22) Filed: Jan. 20, 2015

Related U.S. Application Data
(63) Continuation of application No. PCT/JP2012/004675, filed on Jul. 23, 2012.

(51) Int. Cl. H04L 29/06

(52) U.S. Cl. CPC H04L 63/0428; H04L 63/061; H04L 63/062
USPC 713/171

(57) ABSTRACT

A node device in a network system includes a memory and a processor. The node device is identified with a first value related to a first element and a second value related to a second element. The processor identifies a relay node device capable of cryptographic communications with the node device based on status information in the memory when a first common key is not shared by the node device and a first sharing destination node device not identified with the first value related to the first element and the second value related to the second element, and transmit to the relay node device a request for transfer of the first common key to the first sharing destination node device.

### CROSS-REFERENCE TO RELATED APPLICATION

This application is a continuation application of International Application PCT/JP2012/004675 filed on Jul. 23, 2012, the entire contents of which are incorporated herein by reference.

### FIELD

The embodiment discussed herein is related to encrypted communications between nodes in a network system.

### BACKGROUND

An ad-hoc network has been known as a type of a network. The ad-hoc network is a self-configured network which links by wireless communications. The ad-hoc network is configured by a plurality of devices having a communication function. A device having the communication function in the ad-hoc network is referred to as a node.

Each node in the ad-hoc network transmits or receives a packet with a multi-hop communication. The multi-hop communication is a technology that enables nodes, which are not present in their counterparts' service areas, to communicate with each other through a different node being present in the service area of each node. Note that a path to transfer a packet from a start point to an end point by the multi-hop communication is referred to as a transfer path. A transfer path is formed by a plurality of nodes being present from the start point to the end point.

For example, a meter-reading system has been known as a sensor network system of an ad-hoc type. A node capable of wireless communications is incorporated into a wattmeter of each household, and this meter-reading system gathers consumed electric energy and the like of each household, by way of the ad-hoc network. In this meter-reading system, packets containing information on consumed electric energy of each household which has been detected by each wattmeter are transferred from each node with which a wattmeter of each household is provided to a system of a power company.

From a standpoint of security, it is desirable that data in a packet is encrypted. For example, it is desirable that a data transmission source transmits data to a transmission destination after encrypting the data using a key for data encryption.

For example, a common key encryption method has been known as data encryption. In the common key encryption method, a data transmission source and a data transmission destination share a key for data encryption. To share this key, a conventional technology using Pairwise Key which is distributed in advance to each node has been known.

In this conventional technology, an ID (x, y) is assigned in advance to each node in a sensor network, and a plurality of Pairwise Keys corresponding to IDs are distributed. Then, using a Pairwise Key to be shared only between two nodes, the data transmission source and the data receipt destination share the key for data encryption.

As a conventional technology, Haowen Chan, Adrian Perrig, “PIKE: Peer Intermediaries for Key Establishment in Sensor Networks” (IEEE, IEEE INFOCOM 2005, pp. 524-535) has been known, for example.

In the conventional sensor network, m-squared nodes are first virtually arranged in a matrix of m rows by m columns. Then, an ID (i, j) containing two elements of a row and a column is assigned to each node. Note that a key for encryption of data in a packet is hereinafter referred to as a common key. In addition, a key which is used to share a common key and distributed in advance to each node is hereinafter referred to as a pre-shared key.

FIG. 1 is a view for illustrating a method for distributing a pre-shared key in the conventional sensor network. In FIG. 1, it is assumed that a total of nine nodes are arranged in a matrix of three rows by three columns and an ID is assigned to each node. For example, a node A is assigned an ID of (0, 0) and a node B an ID of (0, 1).

Then, a plurality of pre-shared keys are distributed to each node. The pre-shared key is a key shared by one node and another node having either row or column which is common to the one node.

For example, the node A (0, 0) has a pre-shared key AB with the node B (0, 1). The node A (0, 0) also has a pre-shared key AC with a node C (0, 2). In addition, the node A (0, 0) has a pre-shared key AD with a node D (1, 0). The node A (0, 0) also has a pre-shared key AG with a node G (2, 0). Note that each pre-shared key is a key which is shared only between two nodes and differs from the other pre-shared keys.

When the sensor network including nine nodes is constructed, as illustrated in FIG. 1, four pre-shared keys are distributed in advance to each node.

Since the node A (0, 0) shares the pre-shared key AB with the node B (0, 1), the node A (0, 0) may use the pre-shared key AB to share a common key to be used in encrypted communications with the node B (0, 1). On the one hand, the pre-shared key which the node A (0, 0) has differs from a pre-shared key which a node I (2, 2) has. Thus, the node A (0, 0) uses in the encrypted communications a node which shares a pre-shared key with the node A (0, 0) and which shares a pre-shared key with the node I (2, 2). In the example of FIG. 1, the node A (0, 0) uses the node C (0, 2) or the node G (2, 0) to share a common key used in the encrypted communications with the node C (0, 2).

### SUMMARY

According to an aspect of the invention, a node device of a plurality of node devices included in a network system, each of the plurality of node devices being identified with a pair of a value related to a first element and a value related to a second element, the node device being identified with a first value related to the first element and a second value related to the second element, the node device includes: a memory configured to store a first key corresponding to the first value, a second key corresponding to the second value, and status information related to sharing status of a common key used in cryptographic communications between each node device and the node device for each of the plurality of node devices; and a processor coupled to the memory and configured to: identify a relay node device capable of cryptographic communications with the node device based on the status information when a first common key is not shared by the node device and a first sharing destination node device not identified with the first value related to the first element and the second value related to the second element, and transmit to the relay node device a request for transfer of the first common key to the first sharing destination node device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a method for distributing a pre-shared key of a conventional technology;

FIG. 2 is a view illustrating one example of a network system according to an embodiment;

FIG. 3 is a view illustrating a method for distributing a pre-shared key in the example;

FIG. 4 is a functional block diagram of a node;

FIG. 5 is a data configuration example of a data packet;

FIG. 6 is a view illustrating a data configuration example of a Hello packet;

FIGS. 7A and 7B are views illustrating a data configuration example of pre-shared key information;

FIG. 8 is a view illustrating a data configuration example of a routing table;

FIGS. 9A and 9B are views illustrating a data configuration example of range information;

FIG. 10 is a view illustrating a data configuration example of a common key table;

FIG. 11 is a functional block diagram of a management device 40;

FIG. 12 is a view illustrating a data configuration example of a management table;

FIG. 13 is a flow chart when a node N transmits a data packet;

FIGS. 14, 15 and 16 are a flow chart for a sharing process;

FIGS. 17 and 18 are flow charts when a packet is received;

FIG. 19 is a view illustrating a hardware configuration example of the node N; and

FIG. 20 is a view illustrating one example of hardware configuration of the management device 40.

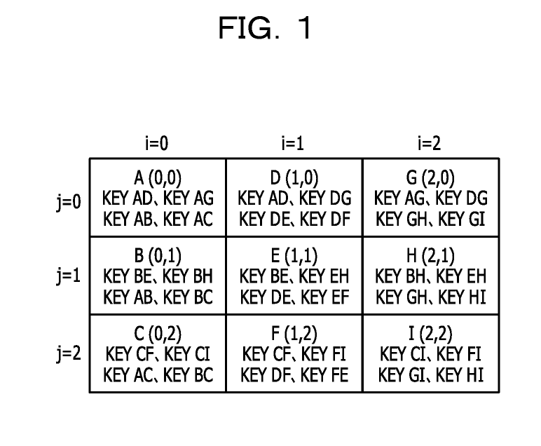

### DESCRIPTION OF EMBODIMENT

In a conventional sensor network, even when an attempt to share a common key is made, it may not be true that sharing of the common key is implemented. For example, when a sharing process of a common key is performed between two nodes and if communications with other node, which serves as a relay between these two nodes, are disabled for any reason, the common key is not shared between these two nodes. Consequently, encrypted communications with the use of the common key is not implemented between these two nodes. Examples of a state in which the communications of the node which serves as a relay are disabled include cases in which that node may not recover from a sleep state, any physical failure has occurred, a battery is dead, and the like.

Hence, an objective of this example is to provide a technology that enables sharing of a common key between two nodes to be implemented with higher probability.

An embodiment of a node, a communication method and a system according to the disclosure is hereinafter described in detail with reference to the accompanying drawings.

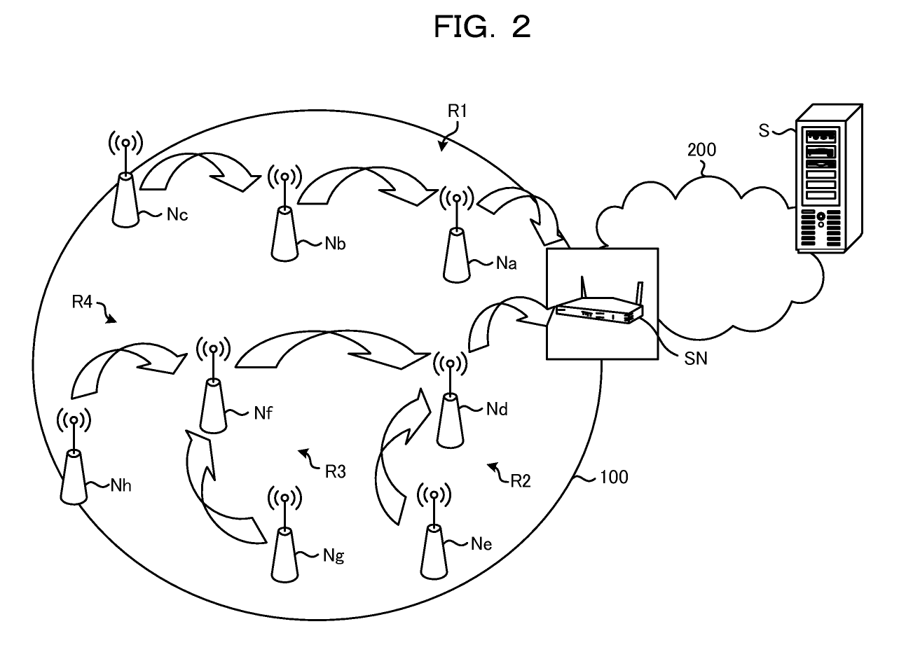

FIG. 2 illustrates one example of a network system according to an embodiment. The network system includes a plurality of nodes N, a sink node SN, and a server S. First, the network system according to the embodiment and transmission of a packet in the network system are described with reference to FIG. 2. The network system according to the embodiment is an ad-hoc network system.

Packets flowing through the ad-hoc network include a data packet and a Hello packet. The data packet is a packet to be unicast. The data packet is a packet to transmit data from a start point to an end point along a transport path. Note that, in this example, types of data packets include a common key data packet to transmit a common key and a sensor data packet to transmit data acquired from a sensor and the like, as described below. The Hello packet is a packet to be broadcasted. The Hello packet is a packet to generate the transport path.

The server S and the sink node SN are coupled by way of a regular network 200 such as an Internet, a LAN, a WAN and the like. The sink node SN and nodes Na to Nh are coupled by way of an ad-hoc network 100. A plurality of nodes N are provided in the ad-hoc network 100. In FIG. 2, the nodes Na to Nh are depicted as representatives of a plurality of nodes.

The server S is a computer configured to manage the ad-hoc network. For example, the server S collects data from each node and accumulates the data. The server S also executes various instructions on the sink node SN or the nodes N.

The sink node SN is a relay device coupling the ad-hoc network 100 and the regular network 200. The sink node SN may transmit and receive both information in a protocol form of the ad-hoc network 100 and information in a protocol form of the regular network 200.

In addition, the sink node SN performs communications by protocol-converting the information between the ad-hoc network 100 and the regular network 200. For example, a data packet transmitted to the server S from any of the plurality of nodes N in the ad-hoc network 100 is protocol-converted at the sink node SN. Then, the sink node SN transmitting the data packet to the regular network 200, the data packet reaches the server S.

In addition, after being protocol-converted at the sink node SN, a data packet transmitted from the server S or the sink node SN to each node N is transmitted from the sink node SN to each node N in the ad-hoc network 100.

Each node N is a device capable of communications among the other nodes capable of communication in a predetermined service area. For example, a node Nc transmits or receives a packet with a node Nb according to a routing table generated at the node Nc. A routing table is a table having information on a transfer path. In addition, the nodes N transmit a value acquired from a sensor to the server S by way of the ad-hoc network.

In the ad-hoc network 100, it is not requested that all the nodes Na to Nh are able to directly communicate with the sink node SN. The nodes Na to Nh communicate with the sink node SN by going through another node. Thus, in the ad-hoc network 100, it suffices that some nodes may communicate with the sink node SN. In FIG. 2, the nodes Na, Nd are each a node capable of directly communicating with the sink node SN.

In addition, each node N encrypts at least a part of data in a packet by a common key. A common key is a key to encrypt data in a data packet. In this example, a session key which is changed in every session is used as a common key.

Specifically, a common key only shared between a node which is a start point and a node which is an end point in a transport path is used. Use of the common key which varies in each session improves the security of the entire network.

Each node uses a pre-shared key or other common key to share a common key. A pre-shared key is assigned to each node in advance. In addition, as described below, to each node is assigned a pre-shared key corresponding with an ID assigned to each node. When one node and another node have a same pre-shared key, those nodes share a common key by exchanging between those nodes a common key encrypted with the pre-shared key.

It may be possible that no common key is shared between two nodes and the two nodes do not share a pre-shared key. Hence, in this example, if one node of the two nodes shares a common key with the other node, sharing of the common key is implemented by way of the other node. Details thereof are described below.

A transport path is described hereinafter. Each node N generates a routing table based on information on communication status with surrounding other nodes N. As such, each node generating a routing table, as appropriate, depending on communication status, setting of a new transmission route is enabled even when communications between a node Nf and a node Ng is disabled. For example, the node Ng may construct a new route that goes through a node Ne.

FIG. 2 illustrates an example of a transport path in a case where each node in the ad-hoc network specifies the server S (or the sink node SN) as a final transmission destination and transmits a data packet. FIG. 2 illustrates that four transport paths R1 to R4 are formed at one point in time by the nodes Na to Nh which constitute the ad-hoc network 100. By following the routed transport paths R1 to R4, the nodes Na to Nh transmit to the sink node SN data detected by each of the Nodes Na to Nh.

For example, the transport path R1 is a route including the node Nc, the node Nb, the node Na and the sink node SN. The transport path R2 is a route including the node Ne, the node Nd and the sink node SN. The transport path R3 is a route including the node Ng, the node Nf, the node Nd and the sink node SN. The transport path R4 is a route including the node Nh, the node Nf, the node Nd and the sink node SN.

A case in which a sensor data packet of data packets is transmitted from the node Nc to the sink node SN is described, for example. Using a common key corresponding to the sink node SN, the node Nc encrypts the data packet. Then, after specifying the sink node SN for a final transmission destination, the node Nc transmits the data packet to the node Nb capable of direct communications with an own node, based on a routing table.

The encrypted data packet goes through the nodes Nb and Na and is received by the sink node SN, which is the final transmission destination. The sink node SN decrypts the data packet generated by the node Nc with the common key which the sink node SN shares with the node Nc. Note that the data packet may be decrypted at the server S rather than at the sink node SN. In that case, the server S manages the common key shared with the node Nc. In this manner, if the node Nc and the server S (or the sink node SN) share the common key, the node Nc may encrypt a data packet.

Here, when one node transmits a data packet to a node with which a common key is not shared, that is, the sink node SN or the server S as a final transmission destination, the node is first requested to share a common key with the final transmission destination. For example, when the node Nc transmits a data packet to the node Nb, and if a common key between the node Nc and the node Nb is not shared by those nodes, the node Nc and the node Nb are requested to share a common key.

In this example, in order to perform encrypted communications between nodes which do not share a common key, a common key is shared through the use of a pre-shared key. In addition, when a common key is mutually shared by nodes which do not share a pre-shared key, the common key is shared by way of a relay node. Details of the sharing of the common key are described below.

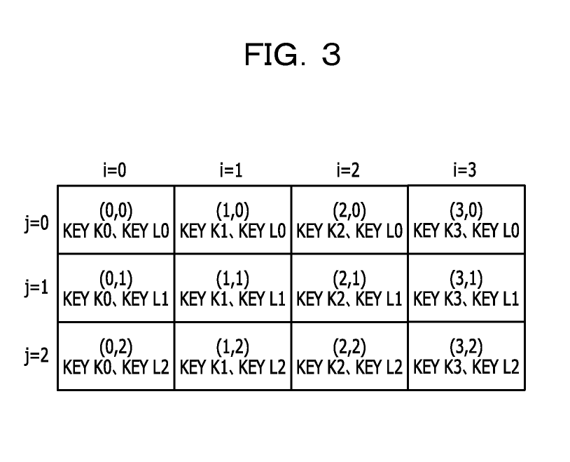

FIG. 3 is to illustrate a method for distributing a pre-shared key in this example. A pre-shared key is generated and distributed before nodes form an ad-hoc network.

In addition, a management device generates and distributes a pre-shared key. While the server S may also function as a management device, in the example, the management device is a computer different from the server S.

First, the management device virtually arranges a plurality of nodes in a matrix of m rows by n columns. Note that virtual arrangement may not be associated with arrangement of the nodes when the ad-hoc network is formed, as illustrated in FIG. 2.

Then, the management device assigns an ID to each node. An ID includes a first element and a second element. In this example, the first element is set in rows of the matrix and the second element in columns of the matrix. Each node is identified with a combination of a value of the first element and a value of the second element in an ID. In FIG. 3, the value of the first element is i, the value of the second element is j, and an ID (i, j) is assigned to each node. Note that i is an integer from 0 to m−1 and j is an integer from 0 to n−1.

In addition, the management device generates one pre-shared key for each element value. In FIG. 3, the management device generates a pre-shared key Ki for every value i of the first element and a pre-shared key Lj for every value j of the second element. For example, a pre-shared key K0 is generated for the value “0” of the first element. In addition, a pre-shared key L0 is generated for the value “0” of the second element.

Then, the management device distributes the pre-shared key generated for every element value to each node, depending on the ID assigned to each node. For example, the pre-shared key K0 and the pre-shared key L0 are distributed to the node to which an ID (0, 0) is assigned. The pre-shared keys may be distributed offline.

The nodes to which the management device assigns the ID and the pre-shared key form the ad-hoc network depicted in FIG. 2. For example, if the ID (0, 0) is assigned to the node Nf in FIG. 2, the node Nf has the pre-shared keys K0 and L0. In addition, if an ID (3, 0) is assigned to the node Ng, the node Ng has the pre-shared keys K3 and L0.

When a sharing process of a common key Mfg is performed between the node Nf (0, 0) and the node Ng (3, 0), the node Nf (0, 0) and the node Ng (3, 0) share the common key Mfg by using the mutually shared pre-shared key L0. This enables the node Nf and the node Ng to use the shared common key Mfg to perform encrypted communications of the data packet.

A case in which a sharing process of a common key Mfh is performed between the node Nf (0, 0) and the node Nh (3, 2) is described. Here, the node Nf (0, 0) and the node Nh (3, 2) do not have a common pre-shared key since any elements of the IDs assigned to the node Nf (0, 0) and the node Nh (3, 2) have no identical element value.

In this example, the node Nf (0, 0) shares the common key Mfh with the node Nh (3, 2) by requesting a relay node to transfer the common key Mfh to the node Nh (3, 2). For example, other node which has already shared a common key with the node Nf (0, 0) is selected as a relay node. Here, suppose that the node Nf (0, 0) shares a common key Mbf with the node Nb (2, 2) through some previous processing. Also suppose that the node Nf (0, 0) shares a common key Mcf with the node Nc (2, 1).

Using the common key Mbf between the node Nf (0, 0) and the node Nb (2, 2), the node Nf (0, 0) encrypts the common key Mfh for the node Nh (3, 2) and transmits the common key Mfh to the node Nb (2, 2). Using the common key Mbf, the node Nb (2, 2) decrypts the encrypted common key Mfh received from the node Nf (0, 0). Then, the node Nb (2, 2) judges whether or not the node Nb (2, 2) has a common key or a common pre-shared key between the own node and the node Nh (3, 2).

For example, when the node Nb (2, 2) has a common pre-shared key L2 with the node Nh (3, 2), the node Nb (2, 2) uses the pre-shared key L2 to encrypt the common key Mfh. Then, the node Nb (2, 2) transmits to the node Nh (3, 2) the common key Mfh encrypted with the pre-shared key L2. The node Nh (3, 2) decrypts the encrypted common key Mfh received from the node Nb (2, 2) with the pre-shared key L2. This enables the node Nf (0, 0) and the node Nh (3, 2) to share the common key Mfh.

In addition, using the common key Mcf between the node Nf (0, 0) and the node Nc (2, 1), the node Nf (0, 0) encrypts the common key Mfh for the node Nh (3, 2) and transmits the common key Mfh to the node Nc (2, 1). Using the encrypted common key Mcf received from the node Nf (0, 0), the node Nc (2, 1) decrypts the common key Mfh. Then, the node Nc (2, 1) judges whether or not the node Nc (2, 1) has the common key or a common pre-shared key with the node Nh (3, 2).

For example, the node Nc (2, 1) does not have a common pre-shared key with the node Nh (3, 2). Then, the node Nc (2, 1) judges whether or not the node Nc has a common key Mch with the node Nf (0, 0) through some previous processing.

If the node Nc (2, 1) has shared the common key Mch previously, the node Nc (2, 1) transmits to the node Nh (3, 2) the common key Mfh encrypted with the common key Mch. The node Nh (3, 2) decrypts the encrypted common key Mfh received from the node Nc (2, 1) with the common key Mch. This enables the node Nf (0, 0) and the node Nh (3, 2) to share the common key Mfh.

On the one hand, if the node Nc (2, 1) has not shared the common key Mch previously, the node Nc (2, 1) finishes the processing. Note that the node Nc may inform the node Nf (0, 0) that the node Nc has failed to transfer the common key Mfh.

Furthermore, in addition to the method for sharing a common key described earlier, a method for using a relay node identified with a value of an ID of an own node for one element and with a value of an ID which is same as a sharing destination of a common key for the other element is possible. For example, based on the ID (0, 0) of an own node and the ID (3, 2) of a sharing destination node Nh, the node Nf identifies a node identified with the ID (3, 0) or (0, 2) as a relay node.

For example, suppose that the node Nf (0, 0) identifies the node Ng (3, 0) identified with the ID (3, 0), as a relay node. First, using a pre-shared key L0 shared by the own node and the relay node, the node Nf (0, 0) encrypts the common key Mfh for the node Nh. Then, the node Nf (0, 0) transmits the encrypted common key Mfh to the node Ng (3, 0).

Using the pre-shared key L0, the node Ng (3, 0) decrypts the encrypted common key Mfh received from the node Nf (0, 0). The node Ng (3, 0) identifies a pre-shared key K3 to share, based on the ID (3, 0) of the own node and the ID (3, 2) of the node Nh, which is the sharing destination. Then, the node Ng (3, 0) encrypts the common key Mfh using the pre-shared key K3.

The node Ng (3, 0) transmits to the node Nh (3, 2) the common key Mfh encrypted with the pre-shared key K3. Using the pre-shared key K3, the node Nh (3, 2) decrypts the encrypted common key Mfh received from the node Ng (3, 0).

In addition, although the node Nf, the node Ng, and the node Nh are illustrated in FIG. 2 as being arranged in a position where the node Nf, the node Ng, and the node Nh may directly communicate, the node Nf, the node Ng, and the node Nh may not be arranged in the position where the node Nf, the node Ng, and the node Nh may directly communicate. With the ad-hoc communications, since a route for reaching a final transmission destination is formed, as appropriate, by using nodes then capable of communication, the common key encrypted by the pre-shared keys is sent through multi-hop communication to the final transmission destination.

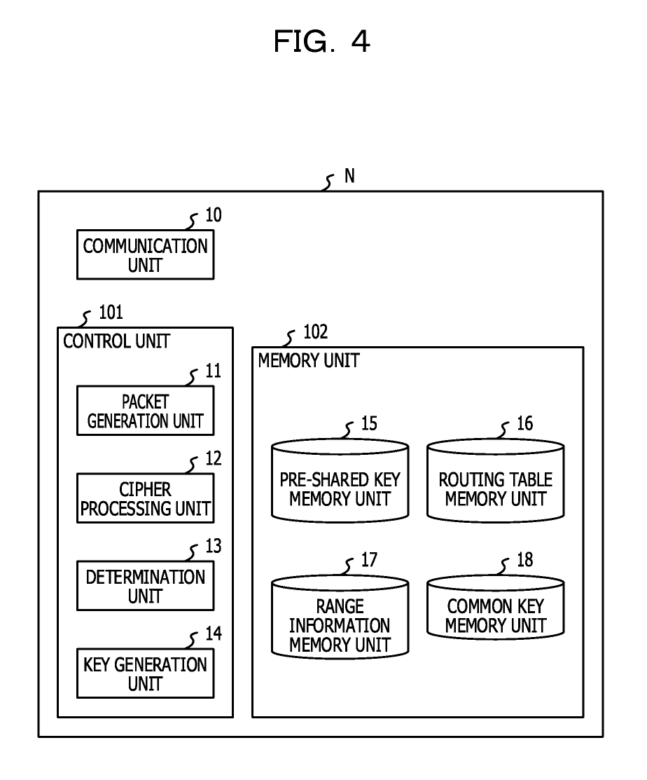

FIG. 4 is a functional block diagram of a node N. The node N has a communication unit 10, a control unit 101, and a memory unit 102.

The communication unit 10 performs communications with other nodes N or a sink node SN. For example, the communication unit 10 transmits a data packet or broadcasts a Hello packet to another node N. For example, if a determination unit 13, to be described below, determines a relay node, the communication unit 10 transmits to the relay node a request to transfer a common key to a sharing destination.

The control unit 101 controls processing of the entire node. The control node 101 includes a packet generation unit 11, a cipher processing unit 12, a determination unit 13, and a key generation unit 14.

The memory unit 102 stores information requested for various processes. The memory unit 102 has a pre-shared key memory unit 15, a routing table memory unit 16, a range information memory unit 17, and a common key memory unit 18.

Then, each processing unit included in the control unit 101 is described. The packet generation unit 11 generates a Hello packet or a data packet. In this example, types of a data packet include a common key data packet to share a common key and a sensing data packet to transmit data acquired by each node.

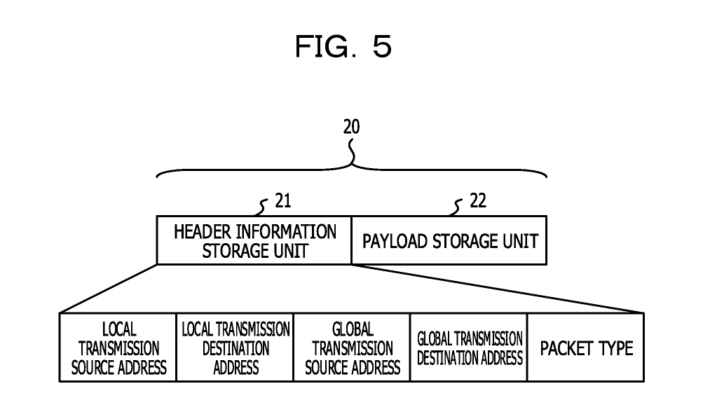

FIG. 5 is a data configuration example of a data packet. A data packet 20 includes a header information storage unit 21 and a payload data storage unit 22. The header information storage unit 21 stores header information. The header information includes a local transmission source address, a local transmission destination address, a global transmission source address, a global transmission destination address, and a packet type. Note that the header information may further include a node ID corresponding to each address.

The local transmission source address is information on an address to which a data packet is transmitted in each communication constituting the multi-hop communication. The local transmission source address is rewritten to an address of a device which performs transmission in each communication.

The local transmission destination address is information on an address of a device which is a transmission destination of a data packet in each communication constituting the multi-hop communication. The local transmission destination address is rewritten to an address of a device which is a transmission destination in each communication.

The global transmission source address is information on an address of a device which is a start point in the multi-hop communication. For example, the global transmission source address is an address of a device which corresponds to a start point of a transfer path. The global transmission source address is not rewritten as far as a data packet is transferred within one transfer path.

The global transmission destination address is information on an address of a device which is a final transmission destination of a data packet. For example, the global transmission destination address is an address of a device which corresponds to an end point of a transfer path. The global transmission destination address is not rewritten as far as a data packet is transferred within one transfer path.

In this example, a data packet is encrypted with a key shared by the global transmission source and the global transmission destination. If the data packet is a common key data packet including a common key, that data packet is encrypted with a pre-shared key or other common key. On the one hand, if the data packet is a sensor data packet, that data packet is encrypted with a common key.

The packet type is information to discriminate a packet type. For example, a packet type “1” is set for a common key data packet of data packets. In addition, for example, a packet type “2” is set for a sensing data packet of data packets. A packet type “3” is set for a Hello packet to be described below, for example.

The payload data storage unit 22 stores payload data. The payload data includes information depending on a packet type. The payload data in a common key data packet includes sharing destination information and sharing source information, and a common key encrypted. The sharing destination information is an ID of a counterpart node which shares a common key. The sharing source information is an ID of a node which generates the common key.

When a data packet is a sensing data packet, the payload data includes data acquired from a sensor and the like.

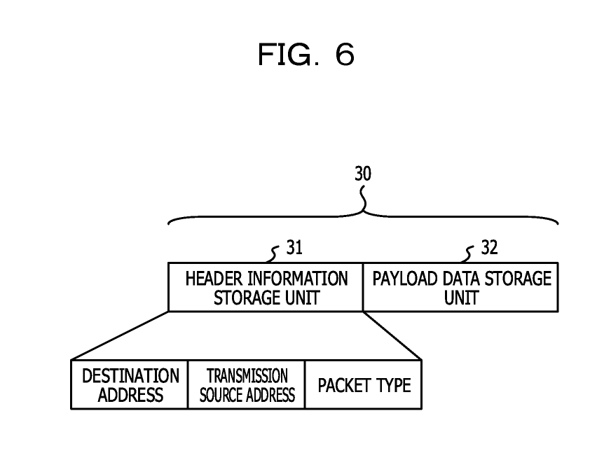

FIG. 6 is a data configuration example of a Hello packet. A data packet 30 includes a header information storage unit 31 and a payload data storage unit 32. The header information storage unit 31 stores header information. The header information includes a destination address, a transmission source address, and a packet type.

The destination address in the Hello packet is a special address dedicated for broadcasting. For example, the destination address is an address “255.255.255.255” prepared in advance. While each node receives a packet transmitted to an individually set address, each node also receives a packet transmitted to the afore-mentioned special address. Specifically, a packet for which a special address is set is received by all nodes present in a range where the nodes may communicate with the node which transmitted the afore-mentioned packet.

The transmission source address is information on an address which transmits a Hello packet. When the Hello packet is sent through multi-hop communication, the transmission source address may have two types of a global transmission source address and a local transmission source address.

The packet type is information to discriminate a packet type. For the Hello packet, “2” is set, for example.

The payload data storage unit 32 stores payload data. The payload data in a Hello packet includes an ID of a node which generates the Hello packet. From the received Hello packet, each node N acquires an ID and an address of a node which is a transmission source of the Hello packet.

Passing a Hello packet between nodes enables identification of communication strength between the nodes. For example, when one node receives large quantities of Hello packets from another node, it means that the communication strength between these nodes is large. Each node N generates a routing table based on this communication strength. A method similar to a conventional method may be adopted for generation of a routing table.

The description goes back to FIG. 4. The cipher processing unit 12 encrypts a data packet. In addition, when the cipher processing unit 12 receives a data packet for which an own node is set as a global transmission destination, the cipher processing unit 12 decrypts the data using a key corresponding to a packet type.

For example, when transmitting a common key data packet, the cipher processing unit 12 encrypts the data packet using a pre-shared key corresponding to the global transmission destination. In addition, when the own node and the global transmission destination have a common pre-shared key, the cipher processing unit 12 uses the pre-shared key for encryption. If the own node and the global transmission destination have already shared a common key, the cipher processing unit 12 uses the common key for encryption.

And, when transmitting a sensor data packet, the cipher processing unit 12 encrypts the sensor data packet using a common key corresponding to the global transmission destination.

When the own node receives a common key data packet which is set as a global transmission destination and when a node specified as a sharing destination of a common key is the own node, the cipher processing unit 12 uses a key corresponding to a global transmission source to decrypt the common key. On the one hand, when the own node receives a common key data packet which is set as a global transmission destination and when a sharing destination is not the own node, the own node is a relay node.

When a common key is shared, the determination unit 13 judges whether or not an own node and a counterpart node share a pre-shared key. As a result of this judgment, if the determination unit 13 judges that the pre-shared key is not shared, the determination unit 13 determines a relay node. The relay node is a node capable of cryptographic communications with the own node and a node other than a sharing destination of a common key with the own node. Note that being capable of cryptographic communications means that a common key has been shared previously through some processing, for example.

For example, the determination unit 13 compares an ID (x, y) of the own node with an ID (u, v) of the counterpart node. If a value of a first element and a value of a second element in the IDs are identical, the determination unit 13 judges that the counterpart node has a common pre-shared key Kx or Ly. Specifically, when the common key is shared, the determination unit 13 instructs the cipher processing unit 12 to use the pre-shared key Kx or Ly.

In addition, if the value of the first element and the value of the second element in the IDs are both not identical, the determination unit 13, for example, refers to a common key memory unit 18 and determines that a node sharing a common key with the own node is a relay node. Note that the common key memory unit 18 is described below.

A key generation unit 14 generates a common key to be used in cryptographic communications between an own node (x, y) and a counterpart node (u, v). Then, the key generation unit 14 associates the generated common key with the ID (u, v) of the counterpart node, which is a sharing destination, and stores the generated common key in the common node memory unit 18.

The pre-shared key memory unit 16 stores pre-shared key information. The pre-shared key information includes a value of each element constituting an ID of an own node and a pre-shared key corresponding to the value of each element. The pre-shared key is information distributed in advance by the management device.

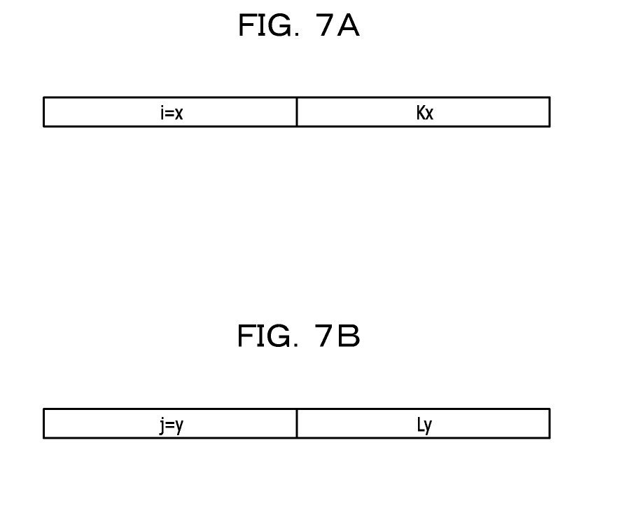

FIG. 7A and FIG. 7B are views illustrating a data configuration example of pre-shared key information. The pre-shared key memory unit 15 associates a value of each element constituting an own node ID with the pre-shared key information corresponding to the value of each element ad stores the information as the pre-shared key information.

For example, when an ID of the node N is (x, y), a pre-shared key Kx is associated with the value “x” of the first element i and stored. In addition, a pre-shared key Ly is associated with the value “y” of the second element j and stored.

The routing table memory unit 16 stores routing information. The routing information is information on a transfer path. One example of the routing information is a routing table.

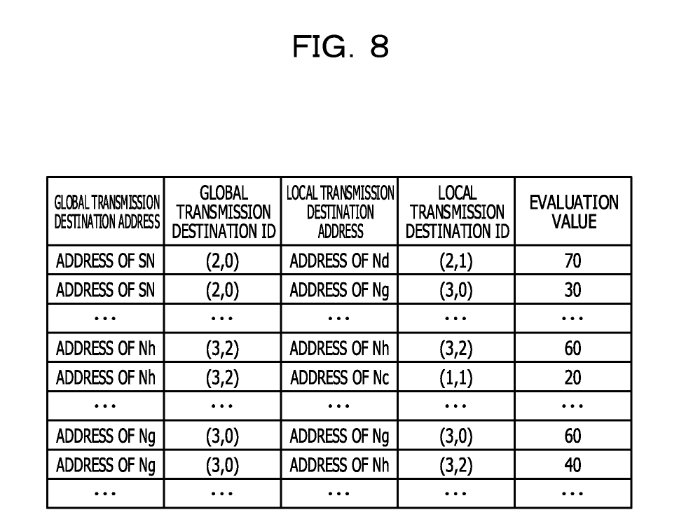

FIG. 8 is a data configuration example of a routing table. The routing table has items of a global transmission destination address, a global transmission destination ID, a local transmission destination address, a local transmission destination ID, and an evaluation value, and associates and stores the items.

As described above, a method similar to a conventional method may be adopted for generation of a routing table. The node N has a technique to generate a routing table and generates a routing table based on a Hello packet. The generated routing table is stored in the routing table memory unit 16. Note that the routing table is regularly updated.

An address of a node which is a global transmission destination of a data packet is depicted in the item “global transmission destination address”. An ID of the node which is the global transmission destination is depicted in the item “global transmission destination ID”.

An address of other node capable of directly communicating with an own node is depicted in the item “local transmission destination address”. An ID of the node which is the local transmission destination is depicted in the item “local transmission destination ID”. Various addresses and IDs are acquired from a Hello packet.

An evaluation value computed depending on communication status between each local transmission destination and an own node is stored in the item “evaluation value”. The larger the communication strength is, the larger a value is set for the evaluation value. The technique to generate a routing table in each node computes an evaluation value related to a transmission source of a Hello packet based on the number of Hello packets received per unit time.

FIG. 8 illustrates a routing table of the node Nf. For example, when the node Nf transmits a data packet to the sink node SN, an “address of Nd” for which the evaluation value corresponds to the largest value is acquired from the routing table as a local transmission destination address.

In addition, in the example of FIG. 8, when the node Nf transmits a data packet to the node Nh, the node Nh is determined as a local transmission destination. Note that this indicates a path by which a data packet reaches a desired node in one hop. However, when the node Nf transmits a data packet to the node Nh, it is requested that the node Nf and the node Nh share a common key. If the node Nf and the node Nh do not share a common key, first, the node Nf performs a process to share a common key.

Then, the range information memory unit 17 in FIG. 4 stores range information. The range information is information on a range of values which each element in the ID related to each node in the network system may take. If a plurality nodes is virtually arranged in a matrix of m rows by n columns and an ID is assigned to each node, a value of a first element in the ID is an integer from 0 to m−1. In addition, a value of a second element in the ID is an integer from 0 to n−1.

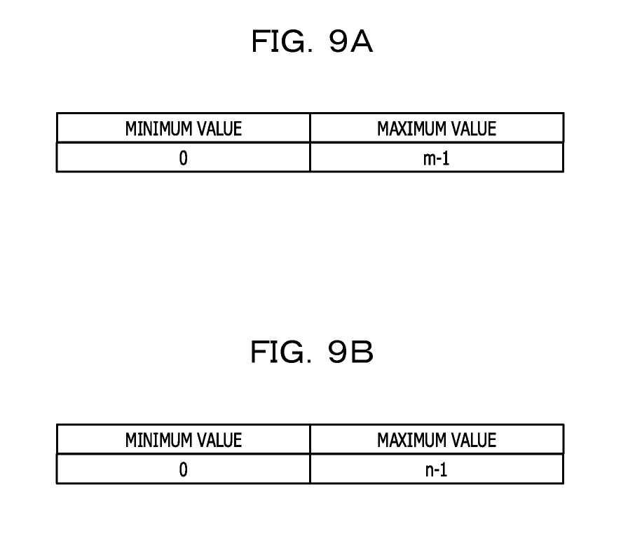

FIG. 9A and FIG. 9B illustrate data configuration examples of range information. The range information stores information on a range of values the afore-mentioned element may take for each element in the ID. FIG. 9A illustrates the range information on a first element in the ID, and FIG. 9B illustrates the range information on a second element in the ID. In the example of FIG. 9A, the ID of the node in a network system indicates that the first element of the ID has a minimum value of “0” and a maximum value of “m−1”. Specifically, it is indicated that the ID of the node in the network system takes an integer from 0 to m−1 as a value of the first element of the ID.

In addition, the example of FIG. 9B indicates that the ID of the node in the network system has a minimum value of “0” and a maximum value of “n−1”. Specifically, it is indicated that the ID of the node in the network system takes an integer from 0 to n−1 as a value of the second element of the ID. Note that only a maximum value of the range which each element may take may be stored as the range information.

The common key memory unit 18 stores status information indicating sharing status of a common key. Status information is information capable of identifying for each node whether or not a common key has already been shared. In this example, a common key table is used as an example of the status information. The common key table associates a node, with which a common key has already been shared, with the shared common key, and stores the node and the shared common key. For a node registered in the common key table, a common key has been shared, while for a node not registered in the common key table, the common key has not been shared.

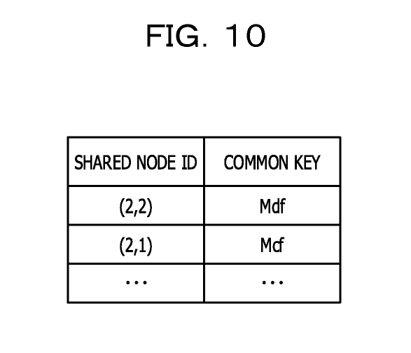

FIG. 10 illustrates a data configuration example of a common key table. A common key table associates a sharing destination ID with a common key and stores the sharing destination ID and the common key. Note that when a common key is regularly updated, the common key table may further hold information on validity of the common key.

FIG. 10 illustrates a common key table which a node Nf to which ID (0, 0) is assigned has. FIG. 10 illustrates that the node Nf already shares a common key Mbf with a node Nb to which ID (2, 2) is assigned has. More specifically, using the common key Mbf, the node Nf (0, 0) is capable of encrypted communications with the node Nb (2, 2).

And, FIG. 10 illustrates that the node Nf already shares a common key Mcf with a node Nc to which ID (2, 1) is assigned has. More specifically, using the common key Mcf, the node Nf (0, 0) is capable of encrypted communications with the node Nc (2, 1). Note that as the common key Mbf or Mcf, a value “0x256451” or a value “0x645125” is stored in the common key table.

In addition, when the node Nf shares a new common key Mfh with a node Nh, an ID (3, 2) assigned to the node Nh and the common key Mfh are associated and newly stored in the common key table.

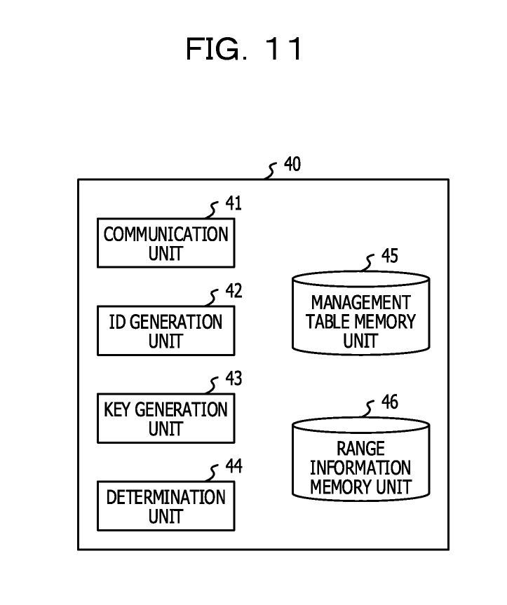

A functional block of the management device is described hereinafter. FIG. 11 is a functional block diagram of a management device 40. In this example, the management device assigns an ID or a pre-shared key to each node. The management device 40 may not be included in the network system or may be a computer independent of the network system. More specifically, the server S and the management device 40 may be coupled via a network or be independent without being coupled.

Note that a server S may have functions of the management device 40. Specifically, the server S may assign IDs and pre-shared keys to all nodes. However, the server S also has functions as a server S in the conventional ad-hoc network system.

The management device 40 has a communication unit 41, an ID generation unit 42, a key generation unit 43, a determination unit 44, a management table memory unit 45, and a range information memory unit 46.

The communication unit 41 communicates with other devices. For example, the communication unit 41 transmits an ID and a pre-shared key corresponding to the ID. Note that an ID and a pre-shared key may be assigned offline without going through a communication network.

The ID generation unit 42 generates a unique ID (i, j) for each node N. First, the ID generation unit 42 stores in the range information memory unit 46 range information indicating a range of values of a first element in an ID and range information indicating a range of values of a second element. Then, the ID generation unit 42 generates an ID having a value in the range of values of the first element and a value in the range of values of the second element which are stored in the range information memory unit 46. Furthermore, the ID generation unit 42 instructs the communication unit 41 to transmit the generated ID to each node. In addition, the ID generation unit 42 instructs the communication unit 41 to transmit to each node the range information.

In this example, depending on the number of nodes which are caused to subscribe to a same network at certain time, a range of values of each element in an ID is first determined. For example, as illustrated in FIG. 3, when a network system including twelve nodes is put into operation, the manager inputs information of 4 rows×3 columns where IDs may be allocated to the twelve nodes, for example.

Then, based on the information entered by the manager, the ID generation unit 42 generates range information having a minimum value of “0” and a maximum value of “3” for the first element. In addition, the ID generation unit 42 generates range information having a minimum value of “0” and a maximum value of “2” for the second element. Then, the ID generation unit 42 assigns an ID to each node based on the generated range information and stores the range information in the range information memory unit 46.

The key generation unit 43 generates a pre-shared key. For example, the key generation unit 43 generates a unique pre-shared key Ki or Lj for every value of each element in an ID. Then, the key generation unit 43 stores values of the respective elements and pre-shared keys corresponding to the values in the management table memory unit 45. For example, if a range of values of a first element in an ID is 0 to m−1, the key generation unit 45 generates a pre-shared key to each of the first element values, associates each value with each pre-shared key, and stores each value associated with each pre-shared key in the management table memory unit 45.

The determination unit 44 determines a pre-shared key to be distributed to each node based on an ID. The determination unit 44 acquires a pre-shared key corresponding to a value of each element in the ID from the management table memory unit 45 and instructs the communication unit 41 to transmit the acquired pre-shared key to the node N.

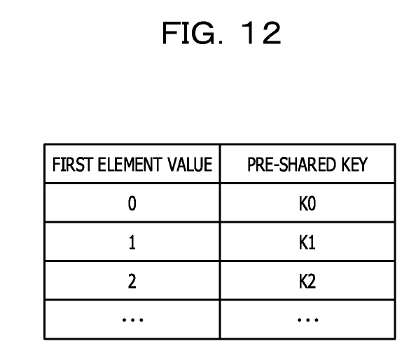

The management table memory unit 45 stores a management table to manage a pre-shared key. FIG. 12 illustrates a data configuration example of a management table. The management table associates a value of each element in an ID with a pre-shared key which is unique for each element value and stores the value of each element and the pre-shared key. For example, as a pre-share key K0 or K1, a value “0x763542” or a value “0x243545” is stored, for example.

Note that the management table illustrated in FIG. 12 is a management table of a pre-shared key for the first element. A management table for the second element structured similarly to the management table illustrated in FIG. 12 is also stored in the management table memory unit 45.

The determination unit 44 refers to the management table memory unit 45 and determines to distribute a pre-shared key K0 associated with a value “0” to a node to which an ID having the first element value of “0” is assigned.

The range information memory unit 46 stores range information on a range of values of an assigned ID. This range information has a data configuration similar to the range information memory unit 17 in the node N.

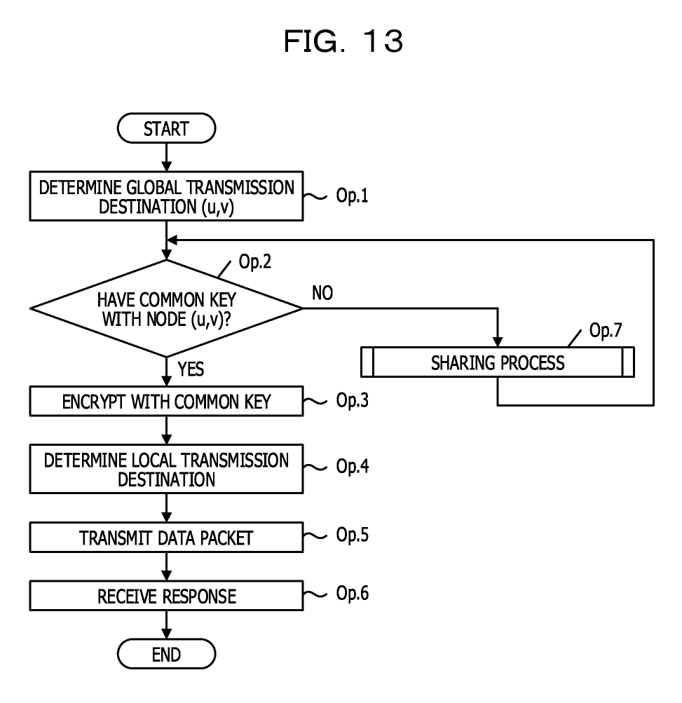

Processing when the node N transmits a data packet is described hereinafter. FIG. 13 is a flow chart when the node N transmits a data packet. The node N performs processing in FIG. 13 when the node N is a global transmission source of the data packet.

In this description, an ID of the node N is represented as (x, y). In addition, prior to the processing in FIG. 13, a control unit 101 of the node N acquires sensor data from a sensor. Then, the node N performs a process to transmit the acquired sensor data in a sensor data packet at predetermined timing.

Under the control of a processor of the node N, the packet generation unit 11 determines a global transmission destination (u, v) of a data packet (Op. 1). For example, a global transmission destination is determined depending on content of sensor data. A type of this data packet is a sensor data packet.

“u” is a first element in an ID and a value included in range information of the first element. Specifically, when the range information on the first element is 0 to m−1, “u” is a value from 0 to m−1. “v” is a second element in an ID and a value included in range information of the second element. Specifically, when the range information on the second element is 0 to n−1, “v” is a value from 0 to n−1.

In Op. 1, the packet generation unit 11 further acquires an address corresponding to the global transmission destination (u, v) from a routing table and stores the acquired address in the header information storage unit 21. In addition, the packet generation unit 11 sets an address of an own node (x, y) for the global transmission destination address in the data packet. Furthermore, the packet generation unit 11 sets “2” indicative of a sensor data packet for a packet type in the data packet.

Then, the cipher processing unit 12 refers to the common key memory unit 18 and judges whether the common key memory unit 18 has a common key to a destination device (node) specified for the global transmission destination (u, v) (Op. 2). When the common key corresponding to the global transmission destination (u, v) is stored in the common key memory unit 18 (Op. 2; YES), the cipher processing unit 12 encrypts sensor data using the common key Op. 3). Furthermore, the cipher processing unit 12 stores payload data including the encrypted sensor data in the payload data storage unit 22 for the data packet. Note that the cipher processing unit 12 may use the common key to encrypt any data other than sensor data.

Then, the packet generation unit 11 refers to the routing table to determine a local transmission destination (Op. 4). The packet generation unit 11 refers to the routing table with the global transmission destination address as a key. Then, the packet generation unit 11 acquires a local transmission destination address to which the largest evaluation value is set, of local transmission destination addresses associated with the global transmission destination address in the routing table.

Then, the packet generation unit 11 sets the acquired local transmission destination address in the header information storage unit 21 for the data packet. The packet generation unit 11 also sets an address of the own node for a local transmission destination address in the data packet.

Then, the communication unit 10 transmits the sensor packet generated as described above (Op. 5). Then, when that sensor data packet is received by a local transmission destination, the communication unit 10 receives a response from a node which is set for the local transmission destination in that sensor data packet (Op. 6). Note that a destination device set for the global transmission destination may also transmit a response.

With the processing described above, the sensor data packet is transmitted from the global transmission source to the global transmission destination. Since the sensor data packet is encrypted with a common key corresponding to the global transmission destination, leakage of information in a transfer path is avoided.

On the one hand, when the node N (x, y) does not have a common key with the node (u, v) (Op. 2; NO), the node N performs a sharing process (Op. 7). Then, when the sharing process ends, the node N returns to Op. 2 to continuously perform a process to transmit the sensor data packet.

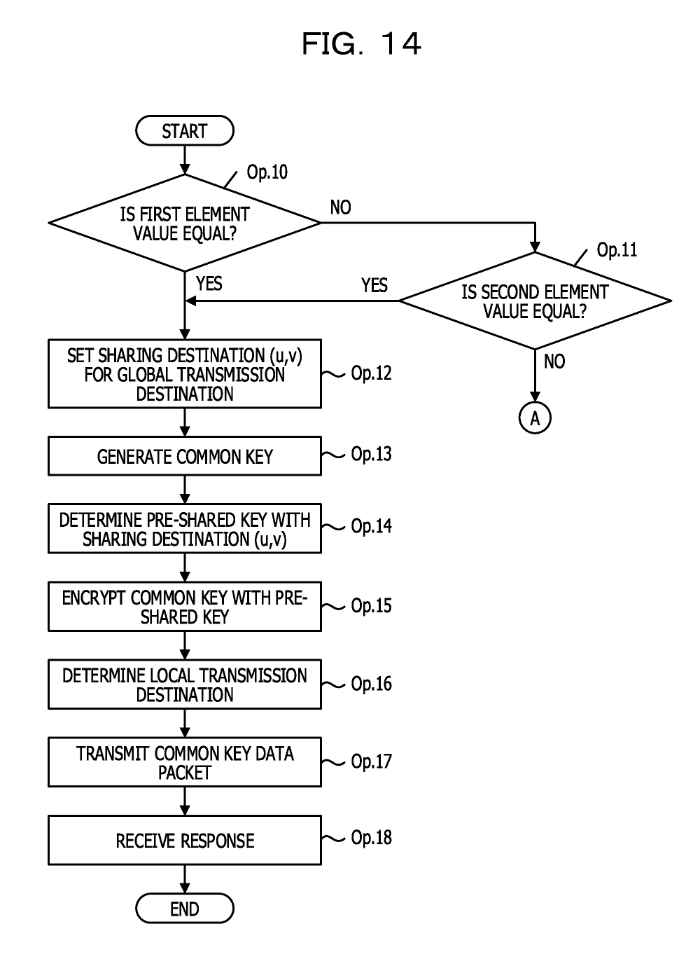

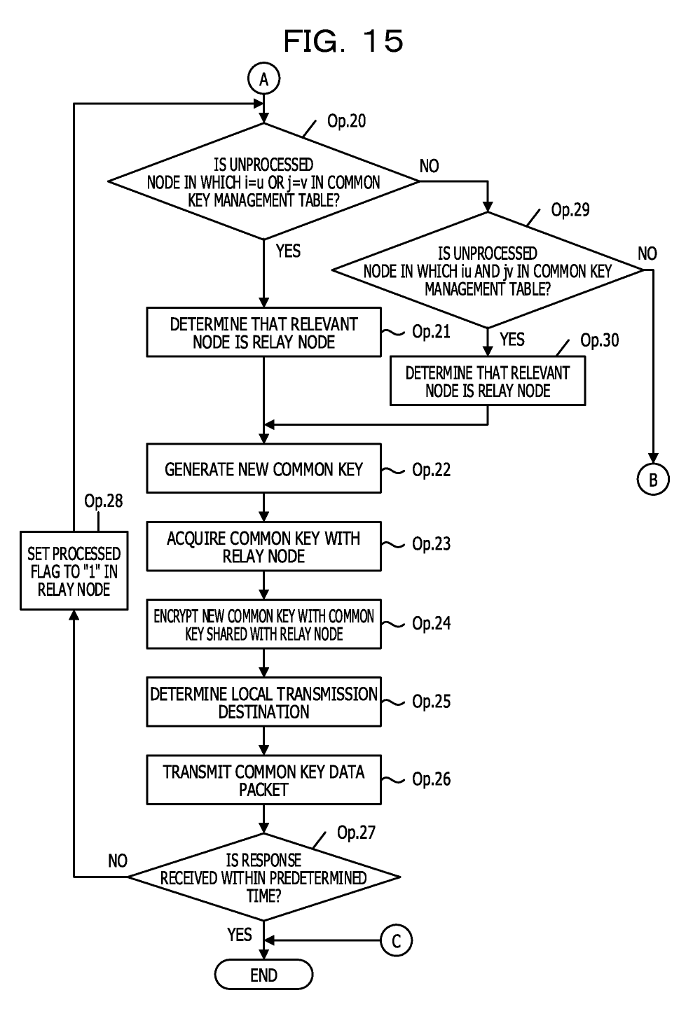

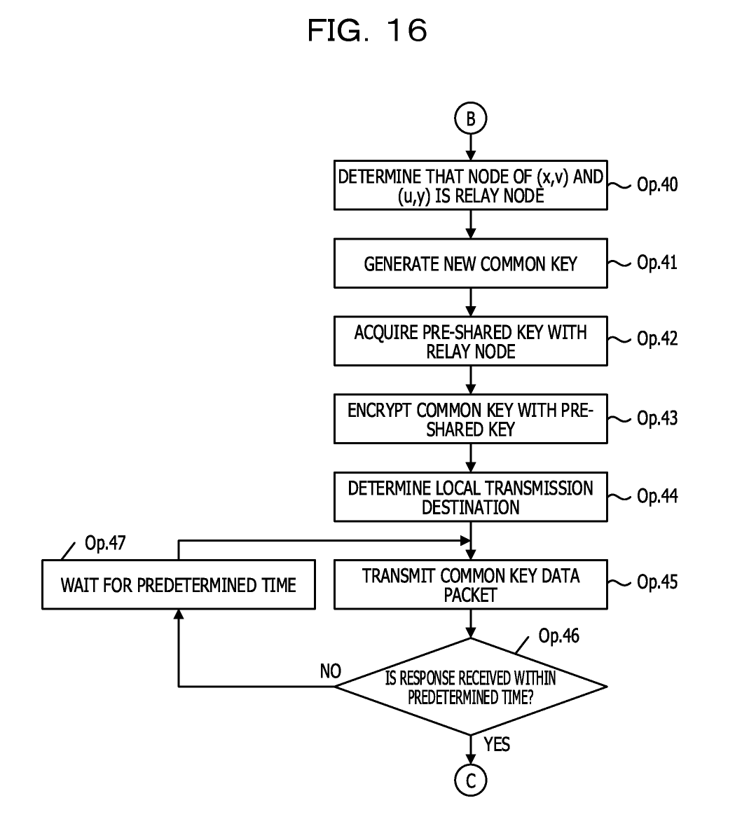

A sharing process when the node N (x, y) sets the global transmission destination (u, v) as a sharing destination of the common key is described. FIGS. 14, 15 and 16 are a flow chart of the sharing process.

First, the determination unit 13 compares an ID (x, y) of the own node with an ID (u, v) of a sharing destination and judges whether or not values of first elements in the IDs are equal (Op. 10). If the first element values are equal (u=x) in the own node and the sharing destination (Op. 10; YES), the determination unit 13 determines that the global transmission destination of the common key data packet is the sharing destination (u, v).

Then, in response to the determination, the packet generation unit 11 sets the global transmission destination of the common key data packet for the sharing destination (u, v) (Op. 12). The packet generation unit 11 sets an address of the global transmission destination (u, v) for the global transmission destination address of the common key data packet. In addition, the packet generation unit 11 sets an address of the own node for the global transmission source address of the common key data packet. Furthermore, the packet generation unit 11 sets “1” indicative of the common key data packet for a packet type of the common key data packet.

On the one hand, if the first element values are not equal (u≠x) in the own node and the sharing destination (Op. 10; NO), the determination unit 13 compares the ID of the own node with the ID of the sharing destination to determine whether or not values of second elements in the IDs are equal (Op. 10). If the second element values are equal (v=y) in the own node and the sharing destination (Op. 10; YES), the determination unit 13 determines that the global transmission destination of the common key data packet is the sharing destination (u, v) (Op. 20).

Now, the first element value in the ID of the own node being equal to the first element value in the ID of the sharing destination or the second element value in the ID of the own node being equal to the second element value in the ID of the sharing destination indicates that a pre-shared key is shared by the own node and the sharing destination. Therefore, the own node and the sharing destination may share the common key using the shared pre-shared key without going through a relay node.

Then, the key generation unit 14 generates a common key to be used in encrypted communications between the own node (x, y) and the sharing destination (u, v) (Op. 13). For example, the common key is generated through the use of a random number generator.

Then, the determination unit 13 determines a pre-shared key based on the ID of the global transmission destination and the ID of the own node (Op. 14). For example, when the global transmission source is the sharing destination (u, v) and when “u” and “x”, which are the first elements in the IDs of the sharing destination and the own node (x, y), respectively, are equal, the determination unit 13 determines “Kx” as this pre-shared key. When “v” and “y”, which are the second elements in the IDs of the sharing destination and the own node (x, y) are equal, the determination unit 13 also determines “Ly” as this pre-shared key.

Then, the cipher processing unit 12 uses the pre-shared keys determined by the determination unit 13 to encrypt the common key (Op. 15). Furthermore, the cipher processing unit 12 stores the encrypted common key in the payload data storage unit 22 for the common key data packet. The packet generation unit 11 also stores the ID (u, v) of the sharing destination as the sharing destination of the common key in the payload storage unit 22, the packet generation unit 11 stores the ID (x, y) of the own node as the sharing source.

Then, the packet generation unit 11 refers to the routing table and determines the local transmission destination based on the global transmission destination (Op. 16). In Op. 17, the packet generation unit 11 acquires an address corresponding to the local transmission destination from the routing table and stores the acquired address in the local transmission destination in the header information storage unit 21 for the common key data packet. The packet generation unit 11 also sets the address of the own node for the local transmission source address of the common key data packet.

Then, the communication unit 10 transmits the common key data packet to the local transmission destination address (Op. 17). Then, when that common key data packet is received by the sharing destination which the global transmission is, the communication unit 10 receives a response from the sharing destination (Op. 18).

As described above, when an own node and a sharing destination share a pre-shared key, a global transmission destination and a sharing destination are a same node. Then, using the common pre-shared key, the node N may share a common key with the sharing destination.

On the one hand, when a value of a first element in an ID of the own node is not equal to a value of a first element in each ID of the sharing destination (Op. 10; No) and when a value of a second element in the ID of the own node is not equal to a value of a second element in the ID of the sharing destination (Op. 11; No), the processing proceeds to Op. 20.

The determination unit 13 judges whether or not an unprocessed node to which an ID having a same value as the ID of the sharing destination is assigned is in the common key table (Op. 20). An unprocessed node is a node which is not set for a relay node in the sharing process.

Specifically, when the ID assigned to the sharing destination is (u, v), the determination unit 13 searches in the common key table for a shared node to which an ID whose first element value i is “u” is assigned or a shared node to which an ID whose second element value j is “v” is assigned. The determination unit 13 also judges whether or not the searched shared node is unprocessed. In addition, it is managed by a processed flag whether or not a shared node is subject to the sharing process. The processed flag “0” is assigned to a node which has not been set for a relay node in the sharing process. In contrast, the processed flag “1” is assigned to a node which has been set for a relay node in the sharing process.

When the node which satisfies the conditions is in the common key table (Op. 20; Yes), the determination unit 13 determines that the node is a relay node (Op. 21). Then, based on the determination by the determination unit 13, the packet generation unit 11 sets an address of the relay node for a global transmission destination address. Then, the packet generation unit 11 sets an address of an own node for a global transmission source address. Furthermore, the packet generation unit 11 sets for a packet type “1” indicating that a packet is a common key data packet.

When there is a plurality of unprocessed nodes to which an ID having a same value as an ID of the sharing destination is assigned, the determination unit 13 may sequentially determine those unprocessed nodes as a relay node. The determination unit 13 may also generate a plurality of common key data packets with all corresponding nodes as a relay node, through processing to be described below. However, it is desirable that a common key included in each common key data packet is an identical common key.

As such, when the own node and the sharing destination do not share a common pre-shared key, a common key data packet is transmitted to the sharing destination by way of the relay node. More specifically, the node N once transmits the common key data packet with the relay node as a global transmission destination. Then, the node N may attempt to share the common key by way of the relay node

With Op. 20, a node having a same pre-shared key as the sharing destination is set for a relay node. This is because a relay node having an ID of a same value as an ID of a sharing destination signifies that at least the relay node and the sharing destination have a same pre-shared key.

After a common key data packet is sent back from the own node to the relay node, the relay node and the sharing destination may use the pre-shared key to exchange the common key. More specifically, with the unprocessed node, to which the ID having the same value as the ID of the sharing destination is assigned, being determined to be a relay node, when a common key data packet is transferred from the own node, which is the sharing source, to the relay node, the relay node and the sharing destination are capable of encrypted communications of the common key data packet.

On the one hand, when the unprocessed node to which the ID having the same value as the ID of the sharing destination is assigned is in not in the common key table (Op. 20; No), the determination unit 13 judges whether or not an unprocessed node to which an ID having a different value from the ID of the sharing destination is assigned is in the common key table (Op. 29). Specifically, the determination unit 13 searches in the common key table for a shared node to which an ID whose value of a first element i is a value other than “u” and whose value of a second element j is a value other than “v” is assigned. Note that the determination unit 13 also judges whether or not the searched shared node is unprocessed.

When the unprocessed node to which the ID having the different value than the ID of the sharing destination is assigned is in the common key table (Op. 29; Yes), the determination unit 13 determines that the node is a relay node (Op. 30). Then, based on the determination by the determination unit 13, the packet generation unit 11 sets an address of the relay node for a global transmission destination address. Then, the packet generation unit 11 sets an address of an own node for a global transmission source address. Furthermore, the packet generation unit 11 sets for a packet type “1” indicating that a data packet is a common key data packet.

Then, after the relay node is determined in Op. 21 or Op. 30, the key generation unit 14 generates a new common key (Op. 22). Then, the cipher processing unit 12 acquires a common key shared by the determined relay node and the own node from the common key table (Op. 23).

The cipher processing unit 12 encrypts the common key generated in Op. 22 with the acquired common key. Furthermore, the packet generation unit 11 stores the encrypted common key in the payload data storage unit 22 for the common key data packet. Then, the packet generation unit 11 refers to the routing table and determines a local transmission destination of the common key data packet (Op. 25). Furthermore, the packet generation unit 11 sets an address of the own node for a local transmission source address.

The communication unit 10 transmits the common key data packet generated by the packet generation unit 11 (Op. 26). Note that transmission of a common key data packet to a relay node means that a request for transfer of the common key to a sharing destination is transmitted to the relay node.

Then, the control unit 101 judges whether or not a response is received from the sharing destination within predetermined time (Op. 27). In addition, in this example, when a node specified for the sharing destination acquires a common key, the node transmits a packet related to reception of a response by setting as a global transmission destination the node set as the sharing source.

Therefore, since sharing of the common key is successful when the own node, which is the sharing source, receives a response (Op. 27; Yes), the sharing process ends. In addition, when a response is received, the control unit 101 associates the sharing destination ID with the common key and stores the sharing destination ID and the common key in the common key table.

On the one hand, when the own node, which is the sharing source, does not receive a response (Op. 27; No), sharing of the common key fails. In this case, an attempt to share the common key by way of other relay node is made. Then, the control unit 101 sets to “1” the processed flag related to the relay node of when sharing of the common key fails (Op. 28).

For example, when the node N may not share a common key with the sharing destination by way of the relay node which is determined in Op. 21, the judgment in Op. 29 is made. Although a relay node and a sharing source do not share a pre-shared key, in some cases, the relay node may be capable of encrypted communications with the sharing destination. Thus, in order to implement sharing of a common key between an own node and a sharing destination with higher probability, the sharing process of the common key is performed with the use of other relay node.

In addition, the unprocessed node to which the ID having the different value from the ID of the sharing destination is assigned is not in the common key table (Op. 29; No), the processing proceeds to Op. 40.

Based on the ID (x, y) of the own node and the ID (u, v) of the sharing destination, the determination unit 13 determines that a node to which the ID (x, y) is assigned and a node to which the ID (u, v) is assigned are a relay node (Op. 40). Specifically, the determination unit 13 determines a node (x, v) having the first element value in the ID (x, y) of the own node and the second element value in the ID (u, v) of the sharing destination for a relay node. The determination unit 13 also determines a node (u, y) having the second element value in the ID (x, y) of the own node and the first element value in the ID (u, v) of the sharing destination for a relay node.

Then, the packet generation unit 11 acquires from the routing table an address corresponding to the determined relay node, and stores the address as a global transmission destination address in the header information storage unit 21. Furthermore, the packet generation unit 11 sets an address of the own node as a global transmission destination address, and sets “1” indicating a common key data packet for a packet type.

With Op. 40, a node sharing at least one pre-shared key with an own node and at least one pre-shared key with a sharing destination of a common key is set for a relay node. In this manner, network congestion may be reduced by setting the number of relay nodes to a minimum number (one).

Next, the key generation unit 14 generates a new common key (Op. 41). Then, the cipher processing unit 12 acquires a common pre-shared key between the own node and the relay node based on an instruction of the determination unit 13 (Op. 42). The determination unit 13 instructs the cipher processing unit 12 to use a pre-shared key Kx for a common key data packet to be transmitted to the relay node (x, v). On the one hand, the determination unit 13 instructs the cipher processing unit 12 to use a pre-shared key Ly for a common key data packet to be transmitted to the relay node (u, y).

Next, the cipher processing unit 12 encrypts the common key generated in Op. 41 with the acquired pre-shared key (Op. 43). Furthermore, the packet generation unit 11 stores the encrypted common key in the payload data storage unit 22 for the common key data packet. Then, the packet generation unit 11 refers to the routing table and determines a local transmission destination of the common key data packet (Op. 44). Furthermore, the packet generation unit 11 sets the address of the own node for a local transmission source address.

The communication unit 10 transmits the common key data packet generated by the packet generation unit 11 (Op. 45). Then, the control unit 101 judges whether or not a response is received from the sharping destination within predetermined time (Op. 46). Since sharing of the common key is successful when the response is received (Op. 46; Yes), the control unit 101 finishes the sharing process.

On the one hand, when no response is received (Op. 46; No), sharing of the common key fails. Thus, after waiting for predetermined time, the control unit 101 performs transmission of the common key data packet once again. Note that the node N may transmit to the server S an alarm indicating that sharing of the common key is not possible and finish the processing.

With the processing described above, a common key is shared and encrypted communications are implemented even when an own node and a sharing destination do not have an identical pre-shared key. Furthermore, adoption as a relay node of a node which has already shared a common key increases the probability that a common key is shared between the own node and the sharing destination.

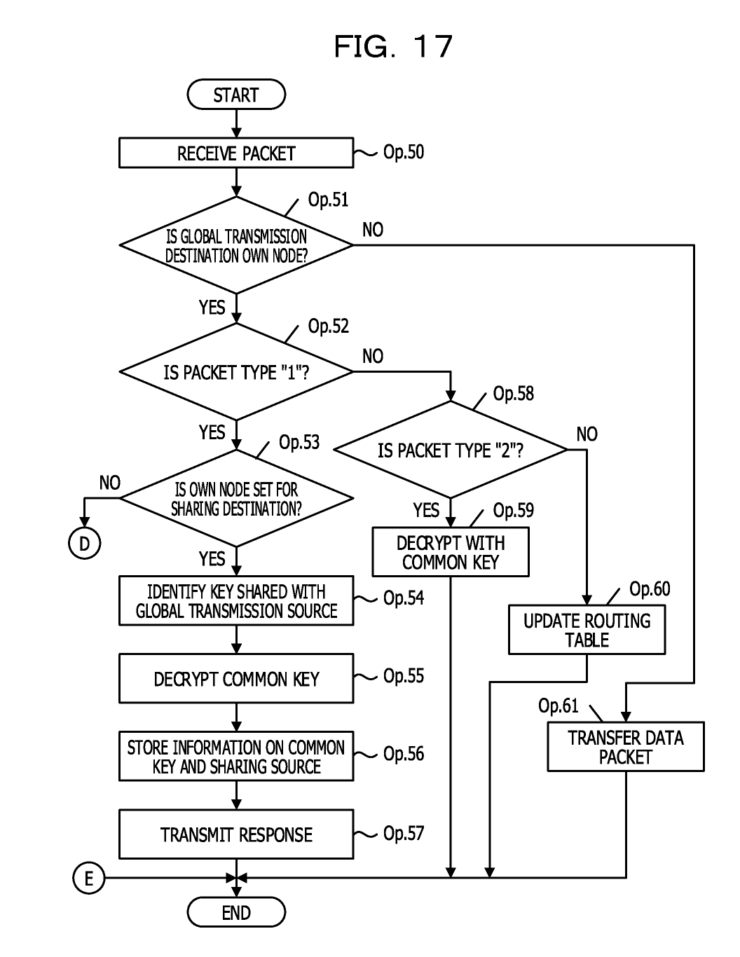

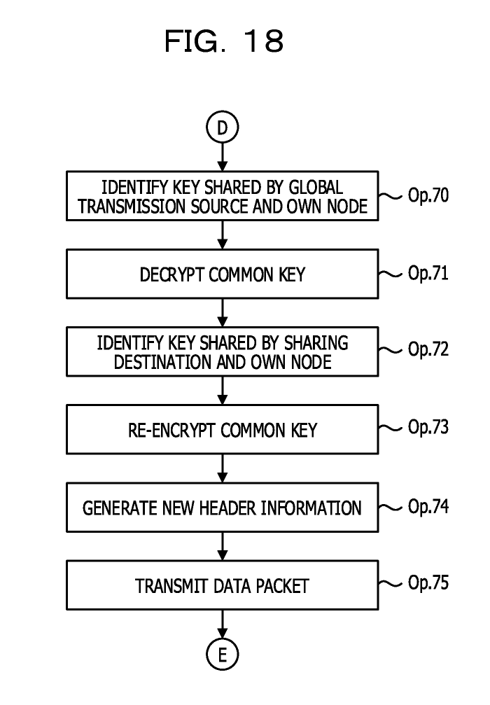

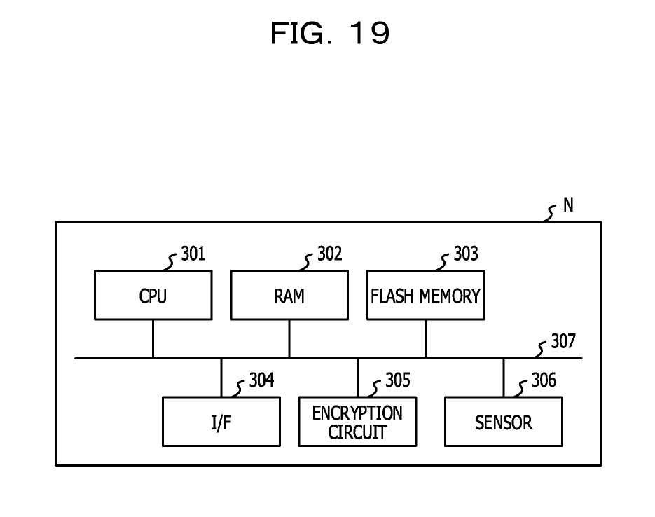

Processing when the node N receives a packet is described hereinafter. FIG. 17 and FIG. 18 are flow charts when a packet is received. When the node N is on the packet receiving side, the processing in FIG. 17 and FIG. 18 is performed.

The communication unit 10 receives a packet (Op. 50). In addition, in this example, each node N receives a packet for which an own node is specified as a local transmission destination or a broadcasted packet. Each node N may refer to the local transmission destination of the received packet, only process a packet with an address of the own node set, and discard a packet with an address of any packet other than the own node set.

The communication unit 10 receives a packet (Op. 50). The control unit 101 judges whether or not the packet received by the communication unit 10 is an own node (Op. 51). When an address of the own node or an address for broadcasting is set for a global transmission destination in the received packet, the control unit 101 judges that the received packet is a packet addressed to the own node. Note that when a Hello packet is received in Op 50, the control unit 101 does not fail to judge YES in the processing of Op. 51.

When the control unit 101 judges that a global transmission destination of the received packet is not the own node (Op. 51; NO), the communication unit 10 transfers the received packet (Op. 61). Prior to this packet transfer, the packet generation unit 11 rewrites a local transmission destination address and a local transmission source address in the received packet, according to a routing table of the own node and depending on the global transmission destination set in the received packet. The packet generation unit 11 rewrites the local transmission destination address in the packet to an address of a counterpart node with which the own node may communicate, and the local transmission source address to the address of the own node. The communication unit 10 transfers the packet thus rewritten by the packet generation unit 11. Then, this processing ends.

On the one hand, when the control unit 101 judges that the global transmission destination of the received packet is the own node (Op. 51; YES), the control unit 101 judges whether or not a packet type of the received packet is “1” (Op. 52). If the packet type is not “1” (Op. 52; NO), the packet generation unit 11 judges whether or not a packet type is “2” (Op. 58).

If the packet type is not “2” (Op. 58; NO), the control unit 101 updates the routing table (Op. 60). In this example, a packet whose global transmission destination is the own node and whose packet type is not “2” is a Hello packet. Note that a conventional technique may be adopted for generation and updating of a routing table. Then, this processing ends.

On the one hand, if the packet type is “2” (Op. 58; YES), the cipher processing unit 12 decrypts the received data packet with a common key (Op. 59). The packet type being “2” signifies that the received packet is a sensor data packet. Thus, the cipher processing unit 12 acquires from the common key memory unit 18 the common key shared by the own node and the global transmission source of the received packet. Then, the cipher processing unit 12 decrypts sensor data in the received data packet using the acquired common key. Then, this processing ends.

On the one hand, in Op. 52, if the packet type is “1” (Op. 52; YES), the received packet is a common key data packet. Thus, the determination unit 13 refers to the payload data storage unit 22 of the common key data packet to judge whether or not the own node is set as a sharing destination (Op. 53).

When a sharing destination is an own node (Op. 53; Yes), the determination unit 13 identifies a key shared by the own node and a global transmission source of a received packet (Op. 54). Specifically, when the own node and the global transmission source has a common pre-shared key, the determination unit 13 identifies the pre-shared key as a key to be shared. On the one hand, when the own node and the global transmission source do not share a common pre-shared key, the determination unit 13 identifies as a key to be shared a common key which was previously shared by the own node and the global transmission source.

It may be judged by comparing the ID of the own node with the ID of the global transmission source whether or not the own node and the global transmission source have a common pre-shared key. First, the determination unit 13 refers to header information (header storage unit 21) for the received packet and acquires an ID corresponding to the global transmission source address. In addition, when the header information does not include the ID, the determination unit 13 refers to the routing table and acquires an ID corresponding to the global transmission source address.

Then, when any of the first element and the second element in the acquired ID has a same value as the ID of the own node, the determination unit 13 judges that the own node and the global transmission source have a common pre-shared key. On the one hand, if the determination unit 13 does not judge that the own node and the global transmission source have a common pre-shared key, the determination unit 13 searches the common key memory unit 18 with the global transmission source ID as a key. As a key to be shared by the own node and the global transmission source, the determination unit 13 identifies a common key which is associated with a shared node ID matching the global transmission source ID and stored in the common key memory unit 18.

Then, the cipher processing unit 12 acquires the identified key from the pre-shared key memory unit 15 or the common key memory unit 18, and decrypts the common key (Op. 55). Then, the control unit 101 associates the common key with the ID of the sharing source and stores the common key and the ID of the sharing source in the common key memory unit 18. Note that the control unit 101 stores the ID of the sharing source in the shared node ID. Furthermore, the control unit 101 transmits a response indicating that the common key data packet is received, to the global transmission destination in the common key data packet (Op. 57).

With the processing described above, a node specified as a sharing destination may obtain a common key generated at a sharing source. Therefore, encrypted communications using a common key is enabled when a sensor data packet is exchanged between a node which is a sharing source and a node which is a sharing destination.

On the one hand, when the sharing destination is not the own node (Op. 53; No), the processing proceeds to Op. 70. This indicates that the own node is a relay node. Thus, the node N performs a process to transfer the received common key data packet to the sharing destination.

The determination unit 13 identifies a key which the global transmission source and the own node share (Op. 70). Note that specific processing is similar to Op. 54. Then, the cipher processing unit 12 decrypts the common key with the specified key (Op. 71).

Then, the determination unit 13 refers to the payload data storage unit 22 for the common key data packet and identifies a key shared by the sharing destination and the own node, based on the ID of the node specified as the sharing destination and the ID of the own node (Op. 72). Specific processing is similar to Op. 54.

However, when an own node is a relay node, there are some cases in which a key may not be shared by a sharing destination of a common key and the own node which is the relay node. In this case, the node N finishes the processing. In addition, in this case, the node N may transmit to the global transmission source a notice indicating that the common key may not be transferred.

The cipher processing unit 12 uses the identified key to encrypt the common key which is decrypted in Op. 71 (Op. 73). Then, the packet generation unit 11 stores the re-encrypted common key in the payload data storage unit 22 for the common key data packet.

Then, the packet generation unit 11 generates new header information (Op. 74). In the new header information, the address of the sharing destination is set for a global transmission destination address and the address of the own node for a global transmission source address. Furthermore, the packet generation unit 11 sets for the local transmission destination address in the header information a local transmission destination address which corresponds to the global transmission destination address acquired by referring to a routing table of the own node, and sets the address of the own node for the local transmission source address.

Then, the determination unit 13 transits the common key data packet newly created in this manner, by way of the communication unit 10 (Op. 75). Then, the sharing process ends.

With the processing described above, when an own node is a relay node, a new shared key data packet which is generated through re-encryption corresponding to a sharing destination is transmitted to a sharing destination. Thus, when the sharing destination receives such a new shared key data packet thus transferred, the own node may obtain a common key to be used with the sharing source by using the key shared by the relay node and the own node.

As described above, according to this example, when a common key is shared between nodes, the common key is shared through the use of a relay node even if the nodes do not have a common pre-shared key. In addition, in consideration of the possibility that each node in a network system is not in a communication-enabled state all the time, this example enables the node N to set other node capable of encrypted communications for various relay nodes and to attempt to share a common key. Therefore, sharing of a common key between nodes is implemented with higher probability than a conventional technology.

FIG. 10 is a hardware configuration example of a node N. The node N includes a central processing unit (CPU) 301, a random access memory (RAM) 302, a flash memory 303, an interface (I/F) 304, an encryption circuit 305, a sensor 306, and a bus 307. The CPU 301 to the sensor 306 are coupled by the bus 307.

The CPU 301 takes control of the entire node N. The CPU 301 functions as a control unit 101 by executing a program loaded in the RAM 302.

The RAM 302 is used as a work area for the CPU 301. The flash memory 303 stores a program, information on various keys, and a routing table. Note that the flash memory 303 is one example of a memory unit 102. The program includes a program to perform each process in the nodes depicted in the flow charts of FIG. 13 to FIG. 18. For example, a control program for causing the node N to perform a process to transmit a data packet, a sharing process, a process to receive a packet is stored in the flash memory 303.

The CPU 301 loading a program stored in the flash memory 303 to the RAM 302 and executing the program, the node N functions as various types of processing units depicted in FIG. 4. The node N also performs the processing in FIG. 13 to FIG. 18.

The I/F 04 transmits a packet with the multi-hop communications. The I/F 304 is one example of the communication unit 10.

The encryption circuit 305 is a circuit to encrypt data with a cipher key when data is encrypted. For example, the encryption circuit 305 functions when a packet is encrypted and transmitted. The encryption circuit 305 is one example of the cipher processing unit 12. Note that when encryption is performed by software, the CPU 301 functions as the cipher processing unit 12. The CPU 301 reads from the flash memory 23 a program corresponding to the encryption circuit 305 and executes the program.

The sensor 306 detects data specific to the sensor 306. For example, the sensor 306 detects data suited to a measurement target, such as temperature, humidity, water level, precipitation, air quantity, sound volume, power usage, time, time of day, acceleration and the like. Note that CPU 301 acquires a detected value from the sensor 306. Then, the CPU 301 transmits the detected data acquired to other devices, as sensor data.

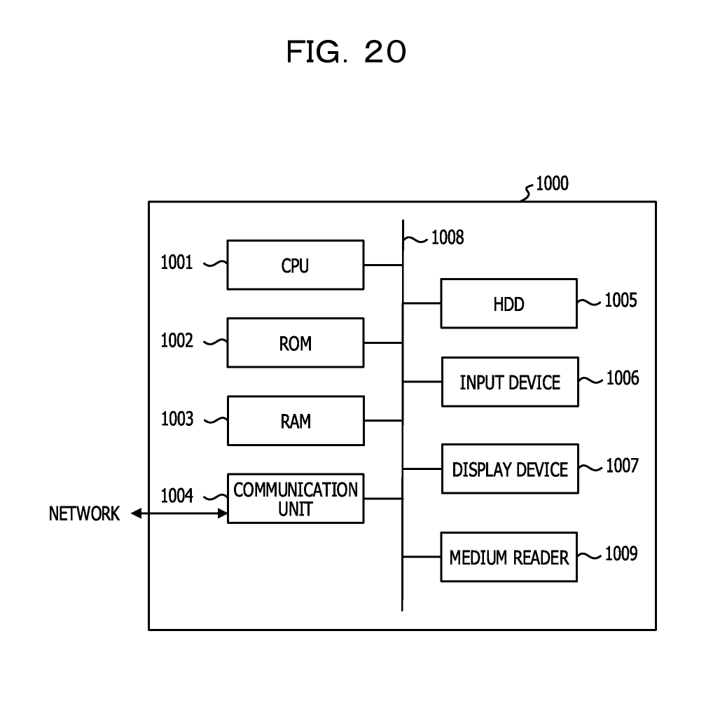

FIG. 20 is a view illustrating one example of a hardware configuration of a server S and a management device 40. A computer 1000 functions as a device having functions of the management device 40 or functions of both the server S and the management device 40.

The computer 1000 has a central processing unit (CPU) 1001, a read only memory (ROM) 1002, a random access memory (RAM) 1003, a communication device 1004, a hard disk drive (HDD) 1005, an input device 1006, a display device 1007, and a medium reader 1009, and each unit is mutually coupled by way of a bus 1008. Then, each unit may transmit or receive data to or from each other under the control of the CPU 1001.

A program for assigning an ID or a pre-shared key is stored in a computer readable recording medium. A computer readable recording medium includes an HDD, a flexible disk (FD), a magnetic tape (MT) and the like. In addition, programs related to the various processes described in this example are recorded in the computer readable recording medium.

An optical disk includes a digital versatile disk (DVD), a DVD-RAM, a compact disk-read only memory (CD-ROM), a CD-R (Recordable)/RW (ReWritable) and the like. A magnetooptical medium includes a magneto-optical disk (MO) and the like. To distribute this medium, it is possible that a portable recording medium in which that program is recorded, such as a DVD, a CD-ROM and the like, is sold.

In the computer 1000, from a recording medium in which various types of programs are recorded, a medium reader 1009 reads the program. The CPU 1001 stores the read program in the HDD 1005, the ROM 102, or the RAM 1003.

The CPU 1001 is a central processing unit which takes control of the entire operations of the management device 40. The HDD 1005 stores a program for causing the computer to perform each process, as a program for causing the computer to serve similar functions to the management device 40 illustrated in each example described above.

Then, by reading the program from the HDD 1005 ad executing the program, the CPU 1001 functions as the ID generation unit 42, the key generation unit 43, and the determination unit 44 in the management device 40 illustrated in FIG. 11. In addition, various programs may be stored in the ROM 1002 or the RAM 1003 to which the CPU 1001 is accessible.

Furthermore, under the control of the CPU 1001, the HDD 1005 functions as the management table memory unit 45 or the range information memory unit 46 illustrated in FIG. 11. Similar to the programs, information in the memory units may be stored in the ROM 1002 or the RAM 1003 to which the CPU 1001 is accessible. In addition, the ROM 1002 or the RAM 1003 stores information which is temporarily generated in the course of processing. The display device 1007 displays each screen, as appropriate.

The communication device 1004 receives a signal from other device by way of a network and passes content of that signal to the CPU 1001. The communication device 1004 further transmits a signal to other device by way of the network, depending on an instruction from the CPU 1001. The input device 1006 accepts entry of information from a user.

The ad-hoc network in this example is applied to a system for collecting power usage of households, for example. In such a system, each node N is installed in a wattmeter of each household for detecting power usage of each household. The power usage detected by each node N being transmitted to the server S by way of the sink node SN, it becomes possible for the server S to collect power usage of each household.

For example, suppose that the node N is incorporated in each wattmeter of each household. Each node N transmits power usage of each household to the server S by way of the ad-hoc network 100.

Note that ach node may gauge power usage of each household or each node may acquire from the wattmeter. In addition, each node stores the detected power usage in its own storage area. The sink node SN transmits the power usage of each household received from each node in the ad-hoc network 100 to the server S of the power company by way of the regular network 200. This enables collection of power usage without dispatching an operator on site (each household).

In addition, this network system enables each node to be used in a survey of the environment, for example, as well as collection of power usage, by causing each node to have a sensor function to detect temperature, humidity, amount of light and the like.

### Variation Example 1

In the sharing process illustrated in FIG. 14 to FIG. 16, when a relay node is determined, a relay node is determined based on the judgment in Op. 20, a relay node is determined based on Op. 29, and then a relay node is determined based on Op. 40. However, in the sharing process, first, a shared key data packet may be transmitted to the relay node determined based on Op. 40. Then, when no response is received within predetermined time, a relay node may be determined based on Op. 29. That is to say, the order of the processes is not important in the processes Op. 20, Op. 29, and Op. 40 which are related to determination of a relay node.

### Variation Example 2

In Op.40 of the above-mentioned example, when a node (x, y) and a node (u, v) share a common key, a node (x, v) or (u, y) which is likely to have as few number of hops as possible is determined as a relay node. However, without being limited to this example, an own node and a counterpart node may share a common key by way of a plurality of relay nodes.

For example, when a certain node (x, y) shares a common key with a counterpart node (u, v), the node (x, y) determines that a node to which an ID (x, p) is assigned is a relay node. Here, “p” is an integer other than “y” and within a range of second element values which each node in a network system may take.

Then, the first relay node (x, p) determines that a node to which an ID (q, v) is assigned is a second relay node, for example. Here, “q” is an integer other than “u” and within a range of first element values which each node in a network system may take. Since the second relay node (q, v) has a pre-shared key Lv which is common to the counterpart node (u, v), the second relay node (q, v) uses the pre-shared key Lv to re-encrypt the common key which the certain node (x, y) generates.

In addition, after transmitting the common key data packet to the relay node (x, v) or the relay node (u, y) and receiving no response for predetermined time (Op. 46; No), the determination unit 13 of the node (x, y) may determine a new relay node (x,p). However, p is an integer other than v or y.

### Variation Example 3

This example is applicable to a conventional technology using a Pairwise Key. For example, when determining a relay node, a node refers to status information and sets for a relay node other node which has already shared a common key. On the one hand, the Pairwise Key may be used in sharing of a common key between nodes which share the Pairwise Key.

### Variation Example 4

In this example, while a same pre-shared key is distributed to each node on a row to row or column to column basis in a matrix, as illustrated in FIG. 3, a same pre-shared key may be distributed to each node at intervals of a few columns in a matrix. For example, the management device may distribute a same pre-shared key to each node at intervals of two rows or two columns in a matrix.

### Variation Example 5

Double encryption may be performed on a data packet. For example, encryption in an application layer uses a common key shared with a global transmission destination or a pre-shared key, while encryption in an ad-hoc layer may use an access key shared by a local transmission destination and a local transmission source.

In each communication which constitutes a transfer path, each node performs re-encryption in the ad-hoc layer. Furthermore, at the global transmission destination, which is an end point of the transfer path, decryption in the d-hoc layer is performed with an access key which is shared with a last transmission source. In addition, decryption in the application layer is performed with the common key shared with the global transmission source or the pre-shared key.

As such, use of an access key enables evaluation of validity of a packet among nodes which constitute a transfer path, thus improving the security.

### Variation Example 6

In the example of FIG. 2, while a configuration is such that one sink node SN is provided in the ad-hoc network 100, more than one sink node SN may be provided in one ad-hoc network 100. In addition, in the example of FIG. 2, while the network system is one ad-hoc network 100, more than one ad-hoc network may be included. When a plurality of ad-hoc networks are included, each ad-hoc network includes at least one sink node SN. In this case, the server S is coupled with each sink node SN by way of a regular network. This configuration enables transmission or reception of data between the server S and all nodes N.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A node device of a plurality of node devices included in a network system, each of the plurality of node devices being identified with a pair of a value related to a first element and a value related to a second element, the node device being identified with a first value related to the first element and a second value related to the second element, the node device comprising:
a memory configured to store a first key corresponding to the first value, a second key corresponding to the second value, and status information related to sharing status of a common key used in cryptographic communications between each node device and the node device for each of the plurality of node devices; and
a processor coupled to the memory and configured to:
identify a relay node device capable of cryptographic communications with the node device based on the status information when a first common key is not shared by the node device and a first sharing destination node device not identified with the first value related to the first element and the second value related to the second element, and
transmit to the relay node device a request for transfer of the first common key to the first sharing destination node device.

2. The node device according to claim 1, wherein the processor is configured to:
transmit to the first sharing destination node device the second common key using one of the first key and the second key when the second common key is not shared by the node device and a second sharing destination node device identified with one of the first value related to the first element and the second value related to the second element.

3. The node device according to claim 1, wherein the processor is configured to:
determine that a first node device which has shared a common key identified with a third value related to the first element and used in the cryptographic communications with the node device according to the status information is the relay node when the first sharing destination node device is identified with the third value related to the first element and a fourth value related to the second element.

4. The node device according to claim 3, wherein the processor is configured to:
determine that a second node device identified with the first value related to the first element and the fourth value related to the second value is other relay node device, and
transmit to the other relay node device other request for transfer of the first common key to the first sharing destination node device.

5. The node device according to claim 4, wherein the processor is configured to:
transmit the other request to the other relay node device when receiving no notice indicating that the first common key is received from the first sharing destination node device, within predetermined time from transmission of the request.

6. The node device according to claim 1, wherein the processor is configured to:
store information which associates the first sharing destination node device and the first common key with the status information when receiving a notice indicating that the first common key is received from the first sharing destination node device.

7. A communication method in a network system including a plurality of node devices, each of the plurality of node devices being identified with a pair of a value related to a first element and a value related to a second element, the method comprising:
storing, by a first node device of the plurality of node devices, a first key corresponding to the first value, a second key corresponding to the second value, and status information related to sharing status of a common key used in cryptographic communications between each node device and the first node device for each of the plurality of node devices, the first node device being identified with a first value related to the first element and a second value related to the second element;
identifying, by the first node device, a relay node device capable of cryptographic communications with the first node device based on the status information when a first common key is not shared by the first node device and a first sharing destination node device not identified with the first value related to the first element and the second value related to the second element; and
transmitting to the relay node device, by the first node device, a request for transfer of the first common key to the first sharing destination node device.

8. The communication method according to claim 7, further comprising:
transmitting to the first sharing destination node device the second common key using one of the first key and the second key when the second common key is not shared by the first node device and a second sharing destination node device identified with one of the first value related to the first element and the second value related to the second element.

9. The communication method according to claim 7, further comprising:
determining that a second node device which has shared a common key identified with a third value related to the first element and used in the cryptographic communications with the first node device according to the status information is the relay node when the first sharing destination node device is identified with the third value related to the first element and a fourth value related to the second element.

10. The communication method according to claim 9, further comprising:
determining that a third node device identified with the first value related to the first element and the fourth value related to the second value is other relay node device; and
transmitting to the other relay node device other request for transfer of the first common key to the first sharing destination node device.

11. The communication method according to claim 10, further comprising:
transmitting the other request to the other relay node device when receiving no notice indicating that the first common key is received from the first sharing destination node device, within predetermined time from transmission of the request.

12. The communication method according to claim 7, further comprising:
storing information which associates the first sharing destination node device and the first common key with the status information when receiving a notice indicating that the first common key is received from the first sharing destination node device.
